(19) United States
(12) Patent Application Publication
(10) Pub. No.: US 2025/0304094 A1
(43) Pub. Date: Oct. 2, 2025

(54) VEHICLE SPEED CONTROL DEVICE, VEHICLE SPEED CONTROL SYSTEM, AND INFORMATION PROCESSING METHOD

(71) Applicant: Panasonic Automotive Systems Co., Ltd., Kanagawa (JP)

(72) Inventors: Tsuyoshi OGATA, Kanagawa (JP); Yoshikazu NISHIKAWA, Tokyo (JP)

(73) Assignee: Panasonic Automotive Systems Co., Ltd., Kanagawa (JP)

(21) Appl. No.: 19/086,794

(22) Filed: Mar. 21, 2025

(30) Foreign Application Priority Data
Mar. 26, 2024 (JP) 2024-050421

(51) Int. Cl. B60W 50/14; B60W 30/14; B60W 50/00

(52) U.S. Cl. CPC B60W 50/14; B60W 30/146; B60W 2050/0083; B60W 2050/143; B60W 2050/146; B60W 2520/10; B60W 2552/30; B60W 2556/10

(57) ABSTRACT

A vehicle speed control device includes: an information obtainer that obtains information regarding a curved road in a travel direction of a vehicle; and an information processor that outputs, under a predetermined condition, before the vehicle enters the curved road, a deceleration confirmation signal for confirming, with an occupant of the vehicle, whether reduction of vehicle speed is necessary.

### CROSS REFERENCE TO RELATED APPLICATION

The present application is based on and claims priority of Japanese Patent Application No. 2024-050421 filed on Mar. 26, 2024.

### FIELD

The present disclosure relates to a vehicle speed control device, a vehicle speed control system, and an information processing method for controlling vehicle speed.

### BACKGROUND

A vehicle speed control device that reduces vehicle speed before entering a curved road is conventionally known. Patent Literature (PTL) 1 discloses a method in which, when deceleration by autonomous driving is insufficient, a driver performs a deceleration operation on a vehicle speed control device to cause a further reduction in vehicle speed.

### CITATION LIST

### Patent Literature

PTL 1: Japanese Patent No. 4046085

### SUMMARY

However, the vehicle speed control device disclosed in PTL 1 can be improved upon.

In view of this, the present disclosure provides a vehicle speed control device, and so on, capable of improving upon the above related art.

A vehicle speed control device according to an aspect of the present disclosure includes: an information obtainer that obtains information regarding a curved road in a travel direction of a vehicle; and an information processor that outputs, under a predetermined condition, before the vehicle enters the curved road, a deceleration confirmation signal for confirming, with an occupant of the vehicle, whether reduction of vehicle speed is necessary.

A vehicle speed control system according to an aspect of the present disclosure includes: the vehicle speed control device described above; a detection device that outputs, to the vehicle speed control device, detection information regarding the curved road and a speed of the vehicle; and a notification device that notifies the occupant of confirmation as to whether reduction of vehicle speed is necessary, based on the deceleration confirmation signal.

An information processing method according to an aspect of the present disclosure includes: obtaining information regarding a curved road in a travel direction of a vehicle; and outputting, under a predetermined condition, before the vehicle enters the curved road, a deceleration confirmation signal for confirming, with an occupant of the vehicle, whether reduction of vehicle speed is necessary.

It should be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

A vehicle speed control device, and so on, capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is an outline diagram of a vehicle speed control device and a vehicle speed control system according to an embodiment.

FIG. 2 is a block configuration diagram of the vehicle speed control system.

FIG. 3 is a diagram illustrating an example of details of deceleration control for reducing vehicle speed.

FIG. 4 is a table illustrating an example of past records of control for a vehicle.

FIG. 5 is a flowchart of an information processing method according to the embodiment.

FIG. 6 is a block configuration diagram of a vehicle speed control system according to Variation 1 of the embodiment.

FIG. 7 is a flowchart of an information processing method according to Variation 1 of the embodiment.

FIG. 8 is a block configuration diagram of a vehicle speed control system according to Variation 2 of the embodiment.

### DESCRIPTION OF EMBODIMENTS

### (Circumstances Leading to the Present Disclosure)

Although auto cruise control (ACC) which assists vehicle operation enables constant-speed traveling at the set vehicle speed, if the vehicle enters a curved road at the same vehicle speed as in a straight road, there are instances where an occupant may feel sick due to sideward G (gravitational acceleration). In view of this, deceleration control for reducing vehicle speed before entering a curved road is performed, but there are cases where the deceleration is still insufficient.

A conventional technique discloses a method in which, when deceleration before entering a curved road is insufficient, an occupant performs a deceleration operation to cause a further reduction in vehicle speed. However, if the occupant performs the deceleration operation each time there is a curved road in the direction of travel of the vehicle, there is the problem that the deceleration operation by the occupant becomes necessary each time, which is troublesome for the occupant.

In contrast, the vehicle speed control device, and so on, according to the present disclosure has the subsequently-described configuration in order to suppress the placing of a heavy burden on the occupant.

Hereinafter, embodiments will be specifically described with reference to the drawings. It is to be noted that each of the following embodiments indicate a specific example of the present disclosure. The numerical values, shapes, materials, elements, and the arrangement and connection of the elements, etc., indicated in the following embodiments are mere examples, and thus are not intended to limit the present disclosure. Among the elements described in the following embodiments, elements not recited in any one of the independent claims are described as optional elements.

Furthermore, each of the figures is a schematic diagram and is not necessarily a precise illustration. Moreover, substantially same elements are given the same reference sign in the figures, and overlapping description is omitted or simplified.

### Embodiment

### [Configurations of Vehicle Speed Control Device and Vehicle Speed Control System]

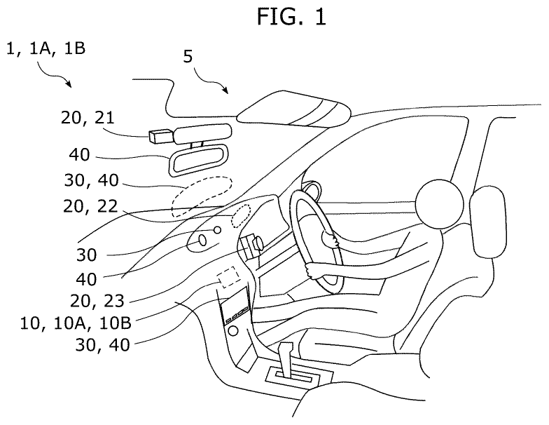

The configurations of a vehicle speed control device and a vehicle speed control system according to an embodiment will be described with reference to FIG. 1 to FIG. 5.

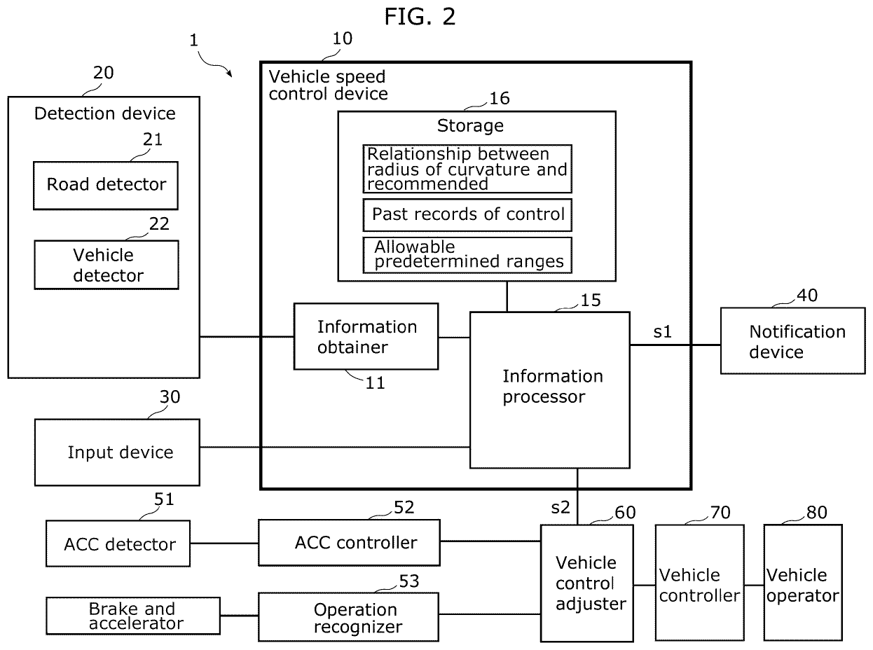

FIG. 1 is an outline diagram of vehicle speed control device 10 and vehicle speed control system 1 according to the embodiment. FIG. 2 is a block configuration diagram of vehicle speed control system 1.

As illustrated in FIGS. 1 and 2, vehicle speed control system 1 includes vehicle speed control device 10 for controlling the vehicle speed, detection device 20, input device 30, and notification device 40. Detection device 20, input device 30, and notification device 40 are communicatively connected to vehicle speed control device 10.

As illustrated in FIG. 2, vehicle speed control system 1 further includes: ACC detector 51 that detects ACC setting details; ACC controller 52 connected to ACC detector 51; operation recognizer 53 that recognizes the driver's operations such as braking and acceleration; vehicle control adjuster 60; vehicle controller 70; and vehicle operator 80 that performs operations such as increasing and decreasing the vehicle speed.

Vehicle speed control device 10, ACC controller 52, and operation recognizer 53 are connected to vehicle operator 80 via vehicle control adjuster 60. Control signals output from vehicle speed control device 10, ACC controller 52, and operation recognizer 53 are input to vehicle control adjuster 60, which processes the control I signals based on predetermined adjustment details.

For example, vehicle control adjuster 60 is adapted to give a higher priority to processing of control signals output from operation recognizer 53 than to processing of control signals output from vehicle speed control device 10 and ACC controller 52. Further, vehicle control adjuster 60 is adapted to give a higher priority to processing of control signals output from vehicle speed control device 10 than to processing of control signals output from ACC controller 52. Vehicle control adjuster 60 selects a control signal with the highest priority among control signals and outputs the selected control signal to vehicle controller 70. Vehicle controller 70 controls vehicle operator 80 based on the control signal output from vehicle control adjuster 60.

The following will describe the configurations of vehicle speed control device 10, detection device 20, input device 30, and notification device 40.

Detection device 20 detects situations inside and outside vehicle 5. Detection device 20 has detectors such as road detector 21 and vehicle detector 22.

Road detector 21 is a sensor that detects roads on which vehicle 5 travels. Road detector 21 detects straight roads and curved roads in the direction of travel of vehicle 5. Examples of road detector 21 include a camera that captures the outside of vehicle 5, and a global positioning system (GPS) sensor that recognizes the coordinate position of vehicle 5. Road detector 21 may detect a curved road based on an image captured by the camera. Further, road detector 21 may also detect a curved road based on the positional coordinates of vehicle 5 obtained by the GPS sensor, and on map information on the area in which vehicle 5 is traveling. Note that road detector 21 may also be a LIDAR (Light Detection And Ranging) sensor.

Vehicle detector 22 is a sensor that detects the speed of vehicle 5. Examples of vehicle detector 22 include a rotational speed detection sensor that detects the rotational speed of the wheels, and an inertial sensor that detects the acceleration and angles of vehicle 5. Vehicle detector 22 may use the rotational speed detection sensor to detect the rotational speed of the wheels or of a rotational axis connected to the wheels, thereby detecting the vehicle speed of vehicle 5. Vehicle detector 22 may use the inertial sensor to detect the speed of vehicle 5, as well as the angles, i.e., the yaw, pitch, and roll angles, of vehicle 5. Detection device 20 outputs the detection information detected by detection device 20 to vehicle speed control device 10.

Notification device 40 notifies an occupant in vehicle 5 of information items output from vehicle speed control device 10.

For example, before vehicle 5 enters a curved road, notification device 40 provides a notification to the occupant for confirming with the occupant whether reduction of the vehicle speed is necessary. Further, before deceleration control, notification device 40 notifies the occupant of the details of the deceleration control to begin deceleration. Examples of notification device 40 include an audio output device such as a speaker, and display devices such as a display and an electronic mirror. Notification device 40 may be a part of a car navigation device, or a part of a human machine interface (HMI) device such as a head-up display.

Input device 30 is a device for inputting information items to vehicle speed control device 10. Input device 30 receives information input from the occupant and outputs the information to vehicle speed control device 10. For example, before vehicle 5 enters a curved road, input device 30 receives information regarding whether reduction of the vehicle speed is necessary and outputs the information to vehicle speed control device 10. Examples of input device 30 include an audio input device such as a microphone, and finger-input devices such as a touch panel and switches. Input device 30 may be a part of a car navigation device, or a part of an HMI device such as a head-up display.

Vehicle speed control device 10 illustrated in FIG. 2 is a device for controlling the travel speed of vehicle 5. Vehicle speed control device 10 includes information obtainer 11, information processor 15, and storage 16 implemented by nonvolatile memory. Storage 16 stores programs for operating information obtainer 11 and information processor 15. Vehicle speed control device 10 may be a part of an electronic control unit (ECU).

Information obtainer 11 obtains information on the inside and outside of vehicle 5 based on information output from detection device 20. Information obtainer 11 in this embodiment obtains information regarding a curved road in the travel direction of vehicle 5.

For example, based on an image captured by detection device 20, as well as map information on the area in which vehicle 5 is traveling and the positional coordinates of vehicle 5, information obtainer 11 obtains information on the distance from the current location of vehicle 5 to the entrance of the curved road, and information on the radius of curvature of the curved road. The curved road in this example refers to a curve with a radius of curvature not greater than 100 m, for example. The radius of curvature may vary with the vehicle position on the curved road. Instead of the radius of curvature of the curved road, information obtainer 11 may obtain the curvature of the curved road. The curvature, being the reciprocal of the radius of curvature, is substantially equivalent to and can replace the radius of curvature.

Further, based on information such as the rotational speed of the wheels and the diameter of the wheels obtained by detection device 20, information obtainer 11 obtains information on the current vehicle speed. Information obtainer 11 may obtain information on the vehicle speed based on the acceleration of vehicle 5 detected by detection device 20, and may obtain information on the travel direction of vehicle 5 based on the angles of vehicle 5 detected by detection device 20.

Note that information obtainer 11 may obtain the information on the inside and outside of vehicle 5 by arithmetically processing row data output from detection device 20, or by receiving processed data resulting from arithmetic processing by detection device 20. The information items obtained by information obtainer 11 are output to information processor 15.

Information processor 15 performs various sorts of information processing based on information obtained by information obtainer 11 and information input via input device 30. Information processor 15 derives deceleration control details for reducing the vehicle speed before vehicle 5 enters the curved road.

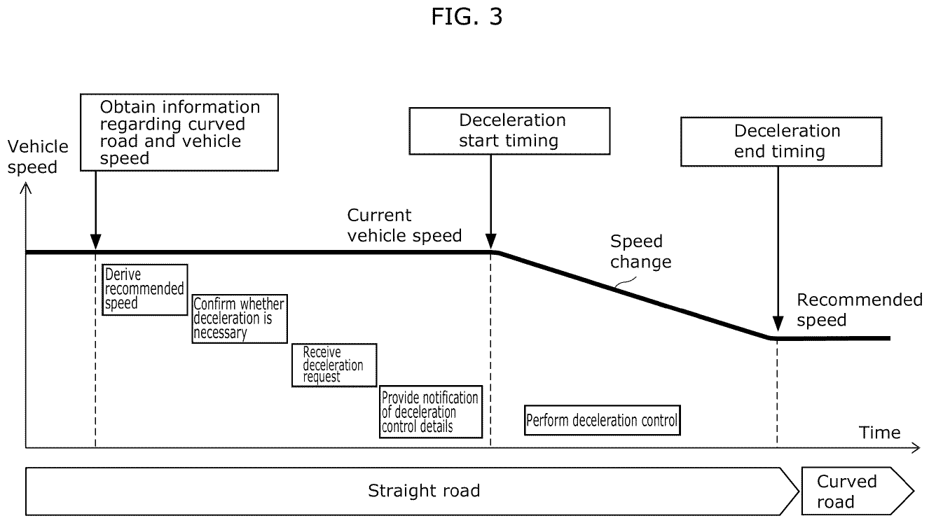

FIG. 3 is a diagram illustrating an example of details of deceleration control for reducing the vehicle speed.

FIG. 3 illustrates details of processing performed in vehicle speed control system 1 after detection device 20 obtains the information regarding the curved road and the current vehicle speed.

For example, information processor 15 derives, based on the radius of curvature of the curved road, the recommended speed for when vehicle 5 turns (travels in a curve) on the curved road. The recommended speed when turning is a value corresponding to the radius of curvature of the curved road. In a case where the radius of curvature varies according to the travel (vehicle) position on the curved road, information processor 15 derives the recommended speed by using the smallest radius of curvature.

Storage 16 stores, as a relational table or a formula, information indicating the relationship between radius of curvature and recommended speed. The information indicating the relationship between radius of curvature and recommended speed is derived in advance by, for example, performing a sensitivity test (or a sensory test). Information processor 15 determines the recommended speed based on the information, stored in storage 16, indicating the relationship between radius of curvature and recommended speed.

Based on the recommended speed for turning, information processor 15 calculates a recommended deceleration value of the vehicle speed. The current vehicle speed is the vehicle speed before deceleration, and the recommended speed for turning is a vehicle speed to be achieved after deceleration. Thus, the recommended deceleration value of the vehicle speed is calculated by subtracting the above recommended speed from the current vehicle speed.

Further, based on the vehicle speed before deceleration, the vehicle speed after deceleration, and the distance from the current location of vehicle 5 to the entrance of the curved road, information processor 15 calculates a deceleration start timing, a deceleration end timing, and speed change from the start of deceleration to the end of deceleration. To avoid sudden speed change at the start and end of deceleration, information processor 15 may derive a speed gradient curve that allows smooth speed change.

Before vehicle 5 enters the curved road, information processor 15 in this embodiment outputs, under a predetermined condition, deceleration confirmation signal s1 for confirming with the occupant of vehicle 5 whether reduction of the vehicle speed is necessary. The predetermined condition regards the existence or nonexistence of past records of control for vehicle 5.

Based on the existence or nonexistence of past records of control for vehicle 5, information processor 15 determines whether to output deceleration confirmation signal s1. If the radius of curvature of the curved road is outside a predetermined range with respect to past records of control, information processor 15 determines that no past records of control exist. First, the case in which no past records of control exist will be described below.

If no past records of control exist, information processor 15 outputs deceleration confirmation signal s1 to notification device 40 to confirm the occupant's intention regarding whether to decelerate vehicle 5.

For example, information processor 15 may confirm the necessity for deceleration by causing notification device 40 to output the voice “Decelerate?” Alternatively, information processor 15 may confirm the necessity for deceleration by causing notification device 40 to display the text “Decelerate?”

After outputting deceleration confirmation signal s1, information processor 15 receives, via input device 30, an answer regarding the necessity for deceleration. For example, information processor 15 may receive an answer regarding the necessity for deceleration by obtaining the voice input “decelerate” or “do not decelerate” via input device 30. Alternatively, information processor 15 may receive an answer regarding the necessity for deceleration by obtaining an input of selecting the text “Yes” or “No” via input device 30.

If a deceleration request indicating that reduction of the vehicle speed is necessary is received by a predetermined timing after the output of deceleration confirmation signal s1, information processor 15 outputs, to notification device 40, deceleration control details for reducing the vehicle speed. For example, information processor 15 may notify the occupant of the deceleration control details by causing notification device 40 to output the voice “The speed will be reduced by 20 km.” Alternatively, information processor 15 may notify the occupant of the deceleration control details by causing notification device 40 to display the text “Speed reduction by 20 km/h.” This notification of deceleration control details is provided prior to entering the curved road and before vehicle 5 is decelerated.

Further, to actually reduce the vehicle speed, information processor 15 performs the following processing. If information processor 15 receives the above deceleration request by the above predetermined timing, information processor 15 outputs, to vehicle control adjuster 60, deceleration control signal s2 for performing deceleration control of the vehicle speed. Deceleration control signal s2 includes information regarding deceleration control details for reducing the vehicle speed before vehicle 5 enters the curved road. The deceleration control details include details regarding the deceleration start timing, the deceleration end timing, the vehicle speed after deceleration, and the speed change from the start of deceleration to the end of deceleration. Vehicle control adjuster 60 sends deceleration control signal s2 output from vehicle speed control device 10 to vehicle controller 70, which controls the operation of vehicle operator 80 based on deceleration control signal s2 received.

If, conversely, an answer indicating no necessity for deceleration is received, information processor 15 does not perform deceleration control; vehicle 5 enters the curved road at the current vehicle speed or at a vehicle speed set for straight roads. Similarly, if no answer regarding the necessity for deceleration is received by the predetermined timing, information processor 15 does not perform deceleration control; vehicle 5 enters the curved road at the current vehicle speed or at a vehicle speed set for straight roads. “By the predetermined timing” means, for example, within the period from the output of deceleration confirmation signal s1 to the deceleration start timing. In these cases, information processor 15 may notify the occupant that vehicle 5 is not decelerated.

Thus, vehicle speed control device 10 in this embodiment includes: information obtainer 11 that obtains information regarding a curved road in the travel direction of vehicle 5; and information processor 15 that outputs, under a predetermined condition and before vehicle 5 enters the curved road, deceleration confirmation signal s1 for confirming with an occupant of vehicle 5 whether reduction of the vehicle speed is necessary. This configuration enables performing vehicle speed control by easily confirming with the occupant of vehicle 5 whether reduction of the vehicle speed is necessary. This can prevent placing a heavy burden on the occupant when performing the vehicle speed control before entry to the curved road.

Next, the case in which past records of control for vehicle 5 exist will be described. For example, information processor 15 uses past records of control to perform deceleration control of the vehicle speed. This can eliminate the need for confirming the necessity for deceleration with the occupant, thereby reducing the burden on the occupant.

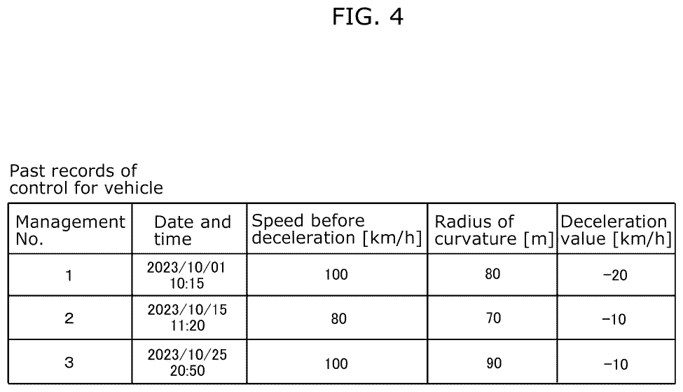

FIG. 4 is a table illustrating an example of past records of control for vehicle 5.

As shown, the exemplary past records of control for vehicle 5 each indicate the management number, the date and time, the vehicle speed before deceleration, the radius of curvature of a curved road, and a deceleration value. These control records are stored in storage 16.

If the radius of curvature of the curved road is within a predetermined range with respect to past records of control, information processor 15 determines that past records of control exist. Note that, to determine the existence of past records of control, information processor 15 may also refer to the date and time and the vehicle speed before deceleration, in addition to the radius of curvature of the curved road, i.e., whether their values are within the respective predetermined ranges with respect to the past records of control.

The allowable predetermined ranges are preset in storage 16. In this example, the allowable predetermined ranges for the date and time, the vehicle speed before deceleration, and the radius of curvature are set to be seven days, ±5 km/h, and ±5 m, respectively. For example, information obtainer 11 may obtain the information “date and time: Oct. 27, 2023, vehicle speed before deceleration: 97 km/h, radius of curvature: 95 m.” This information falls within the predetermined ranges with respect to the control record with management number 3 for the date and time, the vehicle speed before deceleration, and the radius of curvature, respectively. Information processor 15 therefore determines that past records of control for vehicle 5 exist. Further, information processor 15 selects, as a deceleration value of the vehicle speed, the control detail “−10 km/h” in the control record with management number 3. Note that information processor 15 may adjust the deceleration value according to the ratio between the vehicle speed before deceleration and the radius of curvature.

If past records of control for vehicle 5 exist, information processor 15 outputs deceleration control signal s2 for performing deceleration control of the vehicle speed based on the past records of control. Deceleration control signal s2 includes information regarding deceleration control details based on the past records. The deceleration control details include details regarding the deceleration start timing, the deceleration end timing, the vehicle speed after deceleration, and the speed change from the start of deceleration to the end of deceleration. The deceleration control details may include information regarding the recommended speed for turning.

If it is determined that past records of control exist, information processor 15 in this embodiment performs deceleration control without confirming the necessity for deceleration with the occupant. Further, if past records of control exist, information processor 15 notifies the occupant of the deceleration control details through notification device 40.

Thus, if past records of control exist, information processor 15 skips outputting deceleration confirmation signal s1 and outputs deceleration control signal s2 for performing deceleration control of the vehicle speed based on the past records of control. Accordingly, the vehicle speed can be controlled without confirmation with the occupant of vehicle 5 as to whether reduction of the vehicle speed is necessary. This can prevent placing a heavy burden on the occupant when performing the vehicle speed control before entry to the curved road.

### [Information Processing Method]

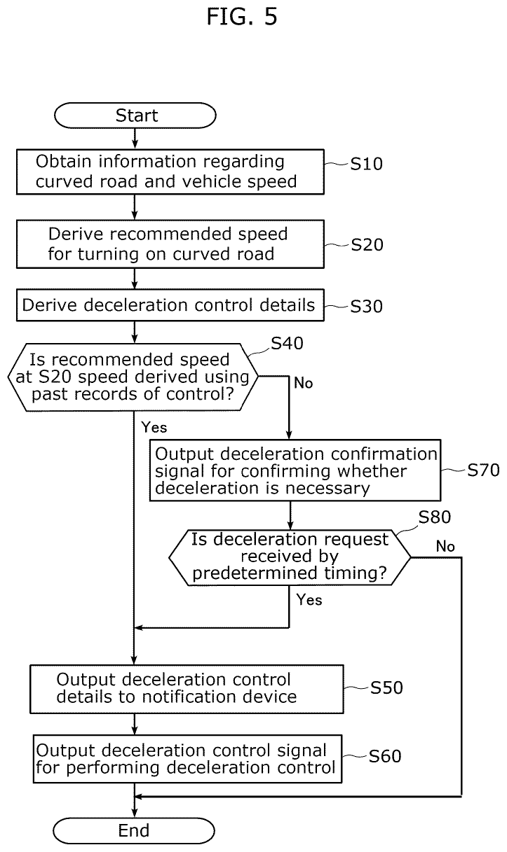

An information processing method according to the embodiment will be described with reference to FIG. 5. The description here focuses on information processing performed in vehicle speed control device 10.

FIG. 5 is a flowchart illustrating an information processing method according to the embodiment.

First, vehicle speed control device 10 obtains information regarding a curved road in the travel direction of vehicle 5 and the vehicle speed of vehicle 5 (step S10).

Next, based on the radius of curvature of the curved road, vehicle speed control device 10 obtains a recommended speed for turning on the curved road (step S20).

For example, if past records of control for vehicle 5 exist, vehicle speed control device 10 derives the recommended speed based on the control record. If no past records of control for vehicle 5 exist, vehicle speed control device 10 derives the recommended speed based on the relationship, stored in storage 16, between radius of curvature and recommended speed.

Next, based on the recommended speed obtained at step S20 and the vehicle speed before deceleration, vehicle speed control device 10 derives deceleration control details (step S30). If past records of control for vehicle 5 exist, vehicle speed control device 10 derives the deceleration control details based on the control record; otherwise, vehicle speed control device 10 derives the deceleration control details through arithmetic operations by information processor 15. The deceleration control details include details regarding a deceleration start timing, a deceleration end timing, a vehicle speed after deceleration, and speed change from the start of deceleration to the end of deceleration.

Next, vehicle speed control device 10 determines whether the recommended speed obtained at step S20 is a speed derived using past records of control (step S40).

If the recommended speed is a speed derived using past records of control (Yes at S40), vehicle speed control device 10 outputs, to notification device 40, deceleration control details indicating the details of deceleration control of the vehicle speed (step S50). The deceleration control details in this case are control details based on the past records of control. Notification device 40 notifies an occupant of the deceleration control details output from vehicle speed control device 10.

Further, if the recommended speed is a speed derived using past records of control, vehicle speed control device 10 outputs deceleration control signal s2 for performing the deceleration control of the vehicle speed (step S60). Deceleration control signal s2 includes information regarding deceleration control details for reducing the vehicle speed before vehicle 5 enters the curved road. Again, the deceleration control details in this case are control details based on the past records of control. Deceleration control signal s2 is output to vehicle controller 70 via vehicle control adjuster 60. Vehicle controller 70 controls vehicle operator 80 based on deceleration control signal s2.

If, conversely, the recommended speed is not a speed derived using past records of control (No at S40), vehicle speed control device 10 outputs deceleration confirmation signal s1 for confirming with the occupant whether reduction of the vehicle speed is necessary (step S70).

Next, vehicle speed control device 10 determines whether a deceleration request, indicating that reduction of the vehicle speed is necessary, is received by a predetermined timing after the output of deceleration confirmation signal s1 (step S80).

If the deceleration request is received (Yes at S80), vehicle speed control device 10 outputs, to notification device 40, deceleration control details indicating the details of deceleration control of the vehicle speed (step S50). The deceleration control details in this case are control details derived based on the relationship, stored in storage 16, between radius of curvature and recommended speed, and on information items obtained by information obtainer 11.

Further, if the deceleration request is received, vehicle speed control device 10 outputs deceleration control signal s2 for performing the deceleration control of the vehicle speed (step S60). Deceleration control signal s2 includes information regarding deceleration control details for reducing the vehicle speed before vehicle 5 enters the curved road. Again, the deceleration control details in this case are control details derived based on the relationship, stored in storage 16, between radius of curvature and recommended speed, and on information items obtained by information obtainer 11. Deceleration control signal s2 is output to vehicle controller 70 via vehicle control adjuster 60. Vehicle controller 70 controls vehicle operator 80 based on deceleration control signal s2.

If, conversely, no deceleration request is received (No at S80), vehicle speed control device 10 terminates the process of this flowchart without performing deceleration control of the vehicle speed. Receiving no deceleration request means receiving an answer indicating no necessity for deceleration, or receiving no answer regarding the necessity for deceleration by the deceleration start timing. If no deceleration request is received, vehicle 5 enters the curved road at the current vehicle speed or at a vehicle speed set for straight roads.

Performing above steps S10 to $80 can prevent placing a heavy burden on the occupant when performing vehicle speed control before entry to the curved road.

### Variation 1 of Embodiment

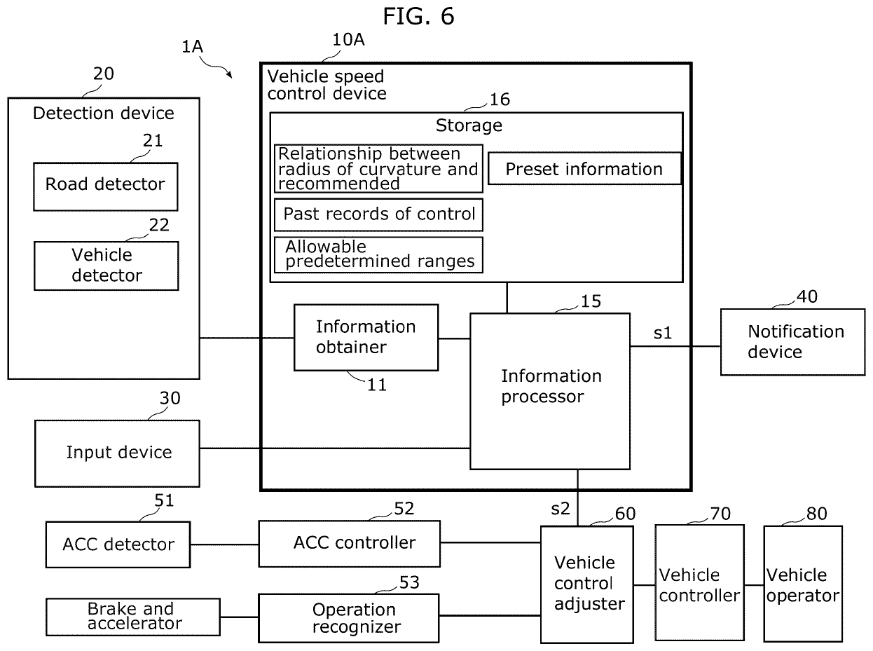

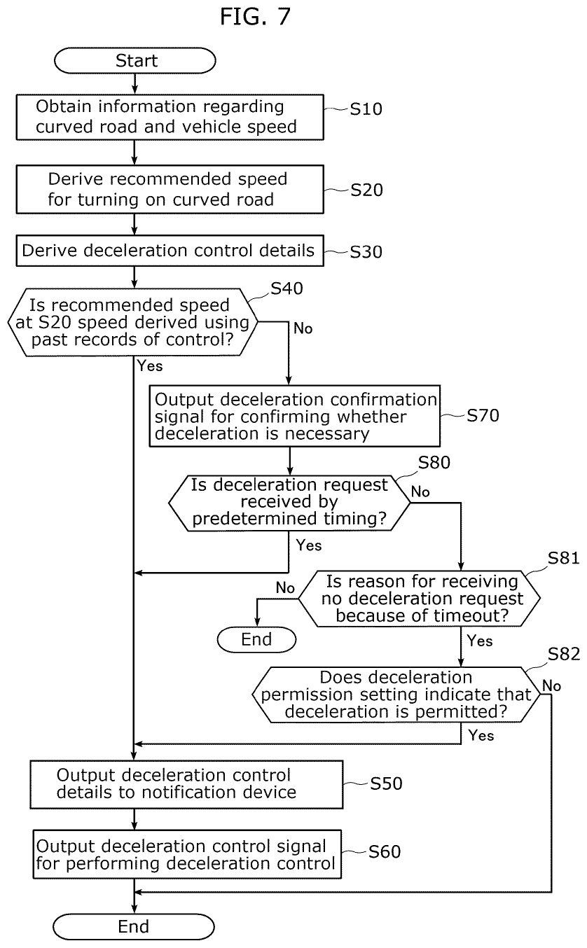

Vehicle speed control device 10A according to Variation 1 of the embodiment will be described with reference to FIGS. 6 and 7. Variation 1 illustrates an example in which vehicle speed control device 10A performs deceleration control based on a deceleration permission setting for vehicle 5 that is input in advance.

FIG. 6 is a block configuration diagram of vehicle speed control system 1A according to Variation 1.

As illustrated in FIG. 6, vehicle speed control system 1A in Variation 1 includes vehicle speed control device 10A, detection device 20, input device 30, and notification device 40. Further, vehicle speed control system 1A includes ACC detector 51, ACC controller 52, operation recognizer 53, vehicle control adjuster 60, vehicle controller 70, and vehicle operator 80. The configurations of the components except vehicle speed control device 10A, i.e., detection device 20, input device 30, notification device 40, ACC detector 51, ACC controller 52, operation recognizer 53, vehicle control adjuster 60, vehicle controller 70, and vehicle operator 80, are the same as those in the embodiment.

Vehicle speed control device 10A includes information obtainer 11, information processor 15, and storage 16. The configuration of information obtainer 11 is the same as that in the embodiment.

In vehicle speed control device 10A in Variation 1, storage 16 stores preset information that includes a deceleration permission setting for curved roads. The preset information is set and input to storage 16 in advance by means such as input device 30. Based on this preset information, information processor 15 performs certain sorts of information processing. If a deceleration request, indicating that reduction of the vehicle speed is necessary, is not received by a predetermined timing after the output of deceleration confirmation signal s1, information processor 15 determines, based on the above deceleration permission setting, whether to output deceleration control signal s2 for performing deceleration control of the vehicle speed.

For example, if the deceleration permission setting indicates that deceleration is permitted, information processor 15 outputs deceleration control signal s2 and performs the deceleration control of the vehicle speed. Deceleration control details in this case are control details derived based on the relationship, stored in storage 16, between radius of curvature and recommended speed, and on information items obtained by information obtainer 11.

If, conversely, the deceleration permission setting indicates that deceleration is not permitted, information processor 15 does not output deceleration control signal s2 and vehicle 5 maintains the current vehicle speed. Variation 1 can thus prevent placing a heavy burden on the occupant when performing the vehicle speed control before entry to the curved road.

FIG. 7 is a flowchart illustrating an information processing method according to Variation 1 of the embodiment. Steps S10 to S70 are the same as those in the embodiment.

Vehicle speed control device 10A in Variation 1 determines whether a deceleration request, indicating that reduction of the vehicle speed is necessary, is received by a predetermined timing after the output of deceleration confirmation signal s1 (step S80). If the deceleration request is received (Yes at S80), the subsequent process is the same as that in the embodiment and therefore will not be described.

If no deceleration request is received (No at S80), vehicle speed control device 10A in Variation 1 determines whether the reason for receiving no deceleration request is because of timeout (step S81). Timeout refers to receiving no answer regarding the necessity for deceleration by the predetermined timing. If the reason for receiving no deceleration request is not because of timeout (No at S81), it means that the answer regarding the necessity for deceleration indicates no necessity for deceleration. Vehicle speed control device 10A therefore does not perform deceleration control.

If, conversely, the reason for receiving no deceleration request is because of timeout (Yes at S81), vehicle speed control device 10A determines whether the deceleration permission setting indicates that deceleration is permitted (step S82). If the deceleration permission setting indicates that deceleration is not permitted (No at S82), vehicle speed control device 10A terminates the process of this flowchart without outputting deceleration control signal s2.

If, conversely, the deceleration permission setting indicates that deceleration is permitted (Yes at S82), vehicle speed control device 10A outputs deceleration control signal s2 and performs deceleration control of the vehicle speed. Specifically, vehicle speed control device 10A performs the processing at steps S50 and S60. Thus, if no answer is received regarding the necessity for deceleration, Variation 1 may still allow providing a deceleration notification and performing deceleration control.

Note that, if the preset information in storage 16 includes information regarding deceleration control details, information processor 15 may perform deceleration control based on the deceleration control details included in the preset information. For example, information processor 15 may perform deceleration control based on a deceleration value included in the preset information. The deceleration value included in the preset information may be set as a fixed value or a deceleration rate.

Further, information processor 15 may change the deceleration control details at the occupant's request. The occupant's request is a request to change the deceleration control details provided by notification device 40 to the occupant. In response to receiving the occupant's request via input device 30, information processor 15 changes the deceleration control details.

As an example, information processor 15 may receive a voice input such as “slower,” “10 km slower,” “a little faster,” or “5 km faster” via input device 30 and change the deceleration control details based on the voice input. As another example, information processor 15 may receive a text input such as “slower,” “−10 K,” “faster,” or “±5 K” via input device 30 and change the deceleration control details based on the text input. Once the deceleration control is performed according to the changed deceleration control details, information processor 15 may further receive a request and perform deceleration control based on the request.

### Variation 2 of Embodiment

Vehicle speed control device 10B according to Variation 2 of the embodiment will be described. Variation 2 illustrates an example in which deceleration control details are customized for each driver.

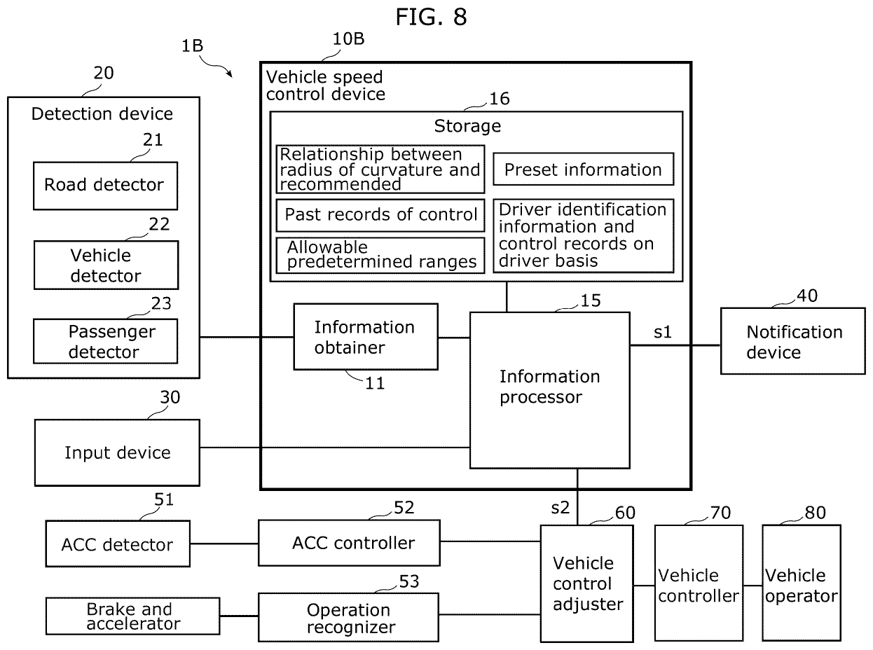

FIG. 8 is a block configuration diagram of vehicle speed control system 1B according to Variation 2 of the embodiment. As illustrated in FIG. 8, vehicle speed control system 1B in Variation 2 includes vehicle speed control device 10B, detection device 20, input device 30, and notification device 40. Further, vehicle speed control system 1B includes ACC detector 51, ACC controller 52, operation recognizer 53, vehicle control adjuster 60, vehicle controller 70, and vehicle operator 80. The configurations of the components except vehicle speed control device 10B and detection device 20, i.e., input device 30, notification device 40, ACC detector 51, ACC controller 52, operation recognizer 53, vehicle control adjuster 60, vehicle controller 70, and vehicle operator 80, are the same as those in the embodiment.

Detection device 20 in Variation 2 includes passenger detector 23 that detects the driver of vehicle 5. An example of passenger detector 23 is a camera that captures the inside of vehicle 5 and identifies the driver of vehicle 5 by performing image recognition on the image captured. For example, passenger detector 23 uses a driver monitoring system (DMS) to identify the driver. The detection information obtained by detection device 20 is output to vehicle speed control device 10B.

Vehicle speed control device 10B includes information obtainer 11, information processor 15, and storage 16. Information obtainer 11 obtains the driver identification information that is output from detection device 20, and outputs it to information processor 15. Information processor 15 stores the driver identification information in storage 16. Further, information processor 15 accumulates, on a driver basis, past records of control (or deceleration control details) in storage 16.

Information processor 15 performs deceleration control based on the driver identification information detected by detection device 20 and a control record (or deceleration control details) for the identified driver accumulated in storage 16. Thus, deceleration control is performed based on the control records on a driver basis. If, for example, the driver of vehicle 5 changes, this configuration still allows deceleration control satisfactory to the driver while eliminating the need for bothersome deceleration operations.

### Other Variations of Embodiment

Other variations of the embodiment will be described.

Following the deceleration control of the vehicle speed in response to a deceleration request from the occupant, information processor 15 may ask the occupant about the level of satisfaction (evaluation) with the deceleration control after the turning on the curved road. That is, after deceleration control of the vehicle speed is performed for vehicle 5 to turn on the curved road, information processor 15 may output a satisfaction level confirmation signal for confirming the occupant's level of satisfaction regarding the deceleration control.

For example, information processor 15 may ask about the level of satisfaction with the deceleration control by causing notification device 40 to output the voice “Was the speed in turning on the curved road appropriate?” Alternatively, information processor 15 may ask about the level of satisfaction with the deceleration control by causing notification device 40 to display the text “Was the speed in turning on the curved road appropriate?”

The occupant answers by voice input or finger input, and information processor 15 receives the answer regarding the level of satisfaction via input device 30. For example, the level of satisfaction may be received as one of two levels such as OK (appropriate) and NG (inappropriate); one of three levels such as too slow (−1), appropriate (0), and too fast (1); or one of further more levels such as too slow (−2), a little too slow (−1), appropriate (0), a little too fast (1), and too fast (2). Further, if no answer is received from the occupant within a predetermined period, it may be regarded as an answer indicating “appropriate.”

Information processor 15 may record the occupant's answer as the value of an item in a past record of control, in addition to the values of the items illustrated in FIG. 4. Further, information processor 15 may record the occupant's answer in the control record only if the level of satisfaction is “appropriate” or is a value within a predetermined range (e.g., if −1≤the level of satisfaction ≤1).

Further, if the driver performs an acceleration operation (override) during the deceleration control, information processor 15 may receive, as the occupant's answer regarding the level of satisfaction, the vehicle speed achieved by the acceleration operation. Such vehicle speed control by an acceleration operation may be given a high priority to be reflected in learning by information processor 15.

If the control records include the level of satisfaction, information processor 15 may perform control using a record having a high level of satisfaction.

Further, if the control records include the level of satisfaction, information processor 15 may determine a set speed based on the level of satisfaction. For example, for the level of satisfaction indicating “too slow,” a speed faster than the speed that would result from the specified deceleration value may be determined to be the set speed. Further, for the level of satisfaction indicating a vehicle speed (a vehicle speed achieved by the driver's acceleration operation), that vehicle speed may be determined to be the set speed. After the vehicle speed is modified according to the level of satisfaction in this manner, the occupant may be asked about the level of satisfaction upon turning on the curved road, and the level of satisfaction in the control record may be updated accordingly. Further, if the level of satisfaction is low such as “NG,” “too slow,” or “too fast,” the occupant may again be asked about the level of satisfaction.

Thus, causing the occupant's level of satisfaction to be reflected in future control allows promptly performing vehicle speed control that will highly satisfy the occupant.

### CONCLUSION

Vehicle speed control devices 10, 10A, 10B, and so on, according to an aspect of the present disclosure will be exemplified.

A vehicle speed control device according to Example 1 includes: information obtainer 11 that obtains information regarding a curved road in a travel direction of vehicle 5; and information processor 15 that outputs, under a predetermined condition, before vehicle 5 enters the curved road, deceleration confirmation signal s1 for confirming, with an occupant of vehicle 5, whether reduction of vehicle speed is necessary.

According to this configuration, it is possible to easily confirm with the occupant whether reduction of vehicle speed is necessary, and perform vehicle speed control. Accordingly, it is possible to suppress the placing of a heavy burden on the occupant when performing vehicle speed control before entering the curved road.

A vehicle speed control device according to Example 2 is the vehicle speed control device according to Example 1, further including: storage 16 configured to store past records of control for vehicle 5. The predetermined condition regards existence or nonexistence of the past records of control for vehicle 5. Information processor 15 may determine whether to output deceleration confirmation signal s1, based on the existence or nonexistence of the past records of control stored in storage 16.

According to this configuration, whether reduction of vehicle speed is necessary can be confirmed with the occupant of vehicle 5, based on the existence or nonexistence of past records of control for vehicle 5. For example, when the past records of control exist, deceleration control can be performed using those past records of control, and thus the need to confirm with the occupant whether reduction of vehicle speed is necessary is eliminated. Accordingly, it is possible to suppress the placing of a heavy burden on the occupant when performing vehicle speed control before entering the curved road.

A vehicle speed control device according to Example 3 is the vehicle speed control device according to Example 2, in which information processor 15 may determine that the past records of control do not exist, when a radius of curvature of the curved road is outside a predetermined range compared to the past records of control.

Accordingly, it is possible to appropriately determine the existence or nonexistence of past records of control, and appropriately determine whether to output deceleration confirmation signal s1. Accordingly, it is possible to suppress the placing of a heavy burden on the occupant when performing vehicle speed control before entering the curved road.

A vehicle speed control device according to Example 4 is the vehicle speed control device according to Example 3, in which information processor 15 may output deceleration confirmation signal s1, when the past records of control do not exist.

According to this configuration, it is possible to easily confirm whether deceleration is necessary when past records of control do not exist, and perform vehicle speed control as necessary. Accordingly, it is possible to suppress the placing of a heavy burden on the occupant when performing vehicle speed control before entering the curved road.

A vehicle speed control device according to Example 5 is the vehicle speed control device according to Example 4, in which, when information processor 15 receives a deceleration request after outputting deceleration confirmation signal s1, information processor 15 may output deceleration control signal s2 for performing deceleration control of the vehicle speed, the deceleration request indicating that the reduction of vehicle speed is necessary.

According to this configuration, vehicle speed control can be performed when the deceleration request from the occupant is received. Accordingly, it is possible to suppress the placing of a heavy burden on the occupant when performing vehicle speed control before entering the curved road.

A vehicle speed control device according to Example 6 is the vehicle speed control device according to any one of Examples 1 to 5, in which information processor 15 may output deceleration confirmation signal s1 to notification device 40 that is communicably connected to the vehicle speed control device.

Accordingly, it is possible to notify the occupant that vehicle 5 will decelerate.

A vehicle speed control device according to Example 7 is the vehicle speed control device according to Example 2, in which information processor 15 may determine that the past records of control exist, when a radius of curvature of the curved road is within a predetermined range compared to the past records of control.

Accordingly, it becomes possible to appropriately determine the existence or nonexistence of past records of control, and perform vehicle speed control based on the past records of control used in the determining. Accordingly, it is possible to suppress the placing of a heavy burden on the occupant when performing vehicle speed control before entering the curved road.

A vehicle speed control device according to Example 8 is the vehicle speed control device according to Example 2 or 7, in which, when the past records of control exist, information processor 15 may output deceleration control signal s2 for performing deceleration control of the vehicle speed based on the past records of control, without outputting deceleration confirmation signal s1.

Accordingly, vehicle speed control can be performed based on past records of control. Accordingly, it is possible to suppress the placing of a heavy burden on the occupant when performing vehicle speed control before entering the curved road.

A vehicle speed control device according to Example 9 is the vehicle speed control device according to Example 5 or 8, in which deceleration control signal s2 may include information regarding deceleration control details for reducing the vehicle speed before vehicle 5 enters the curved road.

According to this configuration, it is possible, for example, to determine the deceleration control details in advance, and cause reduction of vehicle speed based on the deceleration control details. Accordingly, it is possible to suppress the placing of a heavy burden on the occupant when performing vehicle speed control before entering the curved road.

A vehicle speed control device according to Example 10 is the vehicle speed control device according to Example 9, in which the deceleration control details may include details regarding a deceleration start timing, a deceleration end timing, vehicle speed after deceleration, and speed change from start of deceleration to end of deceleration.

According to this configuration, vehicle speed can be appropriately reduced. Accordingly, it is possible to suppress the placing of a heavy burden on the occupant when performing vehicle speed control before entering the curved road.

A vehicle speed control device according to Example 11 is the vehicle speed control device according to Example 4 or 5, in which preset information including a deceleration permission setting for vehicle 5 may be stored in storage 16. When a deceleration request is not obtained by a predetermined timing after deceleration confirmation signal s1 is outputted, information processor 15 may determine, based on the deceleration permission setting, whether to output deceleration control signal s2 for performing deceleration control of the vehicle speed, the deceleration request indicating that the reduction of vehicle speed is necessary.

According to this configuration, it is possible to determine whether deceleration control of the vehicle speed is possible, based on the deceleration permission setting. Accordingly, it is possible to suppress the placing of a heavy burden on the occupant when performing vehicle speed control before entering the curved road.

A vehicle speed control device according to Example 12 is the vehicle speed control device according to Example 11, in which information processor 15 may output deceleration control signal s2 when the deceleration permission setting indicates that deceleration is permitted, and does not output deceleration control signal s2 when the deceleration permission setting indicates that deceleration is not permitted.

According to this configuration, deceleration control of the vehicle speed can be appropriately performed. Accordingly, it is possible to suppress the placing of a heavy burden on the occupant when performing vehicle speed control before entering the curved road.

A vehicle speed control device according to Example 13 is the vehicle speed control device according to any one of Examples 2 to 5, in which information processor 15 may determine the existence or nonexistence of past records of control that is in accordance with a driver of vehicle 5, and, when past records of control by the driver exist, information processor 15 may output deceleration control signal s2 for performing deceleration control of the vehicle speed, based on the past records of control.

Accordingly, vehicle speed control can be performed in accordance with the driver. Accordingly, it is possible to suppress the placing of a heavy burden on the occupant when performing vehicle speed control before entering the curved road.

A vehicle speed control device according to Example 14 is the vehicle speed control device according to Example 5, in which after the deceleration control of the vehicle speed is executed during turning by vehicle 5 on the curved road, information processor 15 may output a satisfaction level confirmation signal for confirming a level of satisfaction of the occupant regarding the deceleration control.

In this manner, by confirming the level of satisfaction of the occupant, the level of satisfaction of the occupant can be reflected in future control. Accordingly, vehicle speed control for which the level of satisfaction of the occupant is high can be promptly performed.

A vehicle speed control system according to Example 15 includes: the vehicle speed control device according to any one of Examples 1 to 14; a detection device that outputs, to the vehicle speed control device, detection information regarding the curved road and a speed of vehicle 5; and a notification device that notifies the occupant of confirmation as to whether reduction of vehicle speed is necessary, based on deceleration confirmation signal s1.

Accordingly, it is possible to provide a vehicle speed control system that can suppress the placing of a heavy burden on the occupant when performing vehicle speed control before entering the curved road.

An information processing method according to Example 16 includes: obtaining information regarding a curved road in a travel direction of vehicle 5; and outputting, under a predetermined condition, before vehicle 5 enters the curved road, deceleration confirmation signal s1 for confirming, with an occupant of vehicle 5, whether reduction of vehicle speed is necessary.

By executing these processes, it is possible to easily confirm with the occupant whether reduction of vehicle speed is necessary, and to perform vehicle speed control. Accordingly, it is possible to suppress the placing of a heavy burden on the occupant when performing vehicle speed control before entering the curved road.

### Other Forms

Although a vehicle speed control device according to one or more aspects has been described above based on the foregoing embodiments, the present disclosure is not limited to the foregoing embodiments. Forms obtained by various modifications to the foregoing embodiments that can be conceived by a skilled person, so long as they do not depart from the essence of the present disclosure, may be included in the scope of the present disclosure.

The foregoing embodiments illustrate examples in which deceleration control details are determined based on past records of control if the records exist. However, this is not limiting. For example, information processor 15 may change the deceleration control details at the occupant's request. In this case, information processor 15 changes the deceleration control details in response to receiving a request from the occupant via input device 30.

Further, as illustrated in (a) or (b) below, the vehicle speed control device may change the deceleration control details by increasing the deceleration value according to the state of a fellow occupant.
(a) Passenger detector 23 identifies fellow occupants using an interior monitoring system (IMS). If it is determined that the fellow occupants include a child, the vehicle speed control device increases the deceleration value at a predetermined rate or by a predetermined value to cause the vehicle to pass through the curved road at a lower speed.
(b) Passenger detector 23 identifies fellow occupants using an interior monitoring system (IMS). If it is determined that the fellow occupants include a preregistered driver, the vehicle speed control device sets a speed based on the largest one of preset deceleration values.

Further, in each of the above manners (a) and (b), upon the fellow occupant identification, the vehicle speed control device may ask the driver whether to change the deceleration from the original set value for the driver.

In examples, deceleration control by vehicle speed control device 10 is applicable to situations in which vehicle speed control device 10 controls speed, and may be implemented during autonomous driving and also during manual driving. Vehicle speed control device 10 is useful as a speed control assistance device for avoiding a risk or an uncomfortable experience due to speeding in entering a curved road during ACC driving, autonomous driving other than ACC driving, or manual driving.

The head-up display mentioned above is a device that displays images in the visual field of the driver of vehicle 5. The head-up display displays an image in the visual field of the driver of vehicle 5 by presenting the image on a display screen that the driver can see through. The display area of the head-up display is disposed closer to the driver's seat on the windshield. The head-up display may also be a combiner that uses a small and transparent plastic disk as the display screen.

For example, in the above embodiments, each of the elements of the processing units included in the vehicle speed control device may be implemented as dedicated hardware or may be realized by executing a software program suited to such element. Alternatively, each of the elements may be implemented by a program executor such as a central processing unit (CPU) or a processor reading out and executing the software program recorded on a recording medium such as a hard disk or a semiconductor memory.

Furthermore, the processing units of the vehicle speed control device may be implemented as a single processor together with an ECU, etc.

It should be noted that the subsequent cases are also included in the present disclosure.
(1) At least one of the devices described above is a computer system configured with, specifically, a microprocessor, a Read Only Memory (ROM), a Random Access Memory (RAM), a hard disk unit, a display unit, a keyboard, a mouse, and so on. The RAM or the hard disk unit stores a computer program. The microprocessor operates according to the computer program, so that the functions of the at least one device are achieved. Here, the computer program includes a combination of instruction codes indicating instructions to be given to the computer so as to achieve a specific function.
(2) Some or all of the elements included in at least one of the devices above may be realized as a single system large scale integration (LSI). The system LSI is a super multifunctional LSI manufactured by integrating a plurality of elements onto a single chip. To be more specific, the system LSI is a computer system configured with a microprocessor, a ROM, and a RAM, for example. The RAM stores a computer program. The microprocessor operates according to the computer program so that a function of the system LSI is achieved.
(3) Some or all of the elements included in at least one of the devices above may be implemented as an IC card or a standalone module that can be inserted into and removed from the device. The IC card or the module is a computer system configured with a microprocessor, a ROM, and a RAM, for example. The IC card or the module may include the aforementioned super multifunctional LSI. The microprocessor operates according to the computer program so that a function of the IC card or the module is achieved. The IC card or the module may be tamper-resistant.
(4) The present disclosure may be the methods described above. Furthermore, the present disclosure may be a computer program for causing a computer to execute each of these methods. Moreover, the present disclosure may be a digital signal of the computer program.

Furthermore, the present disclosure may be the aforementioned computer program or digital signal recorded on a computer-readable recording medium, such as a flexible disk, a hard disk, a Compact Disc (CD)-ROM, a DVD, a DVD-ROM, a DVD-RAM, a Blu-ray (registered trademark) disc (BD), or a semiconductor memory. The present disclosure may also be the digital signal recorded on such a recording medium.

Furthermore, the present disclosure may be the aforementioned computer program or digital signal transmitted via a telecommunication line, a wireless or wired communication line, a network represented by the Internet, and data broadcasting, and so on.

Furthermore, by transferring the recording medium having the aforementioned program or digital signal recorded thereon or by transferring the aforementioned program or digital signal via the aforementioned network or the like, the present disclosure may be implemented by a different independent computer system.

### Further Information about Technical Background to this Application

The disclosure of the following patent application including specification, drawings, and claims is incorporated herein by reference in its entirety: Japanese Patent Application No. 2024-050421 filed on Mar. 26, 2024.

### INDUSTRIAL APPLICABILITY

The present disclosure is useful as a vehicle speed control device that controls vehicle speed before entering a curved road.

1. A vehicle speed control device comprising:
an information obtainer that obtains information regarding a curved road in a travel direction of a vehicle; and
an information processor that outputs, under a predetermined condition, before the vehicle enters the curved road, a deceleration confirmation signal for confirming, with an occupant of the vehicle, whether reduction of vehicle speed is necessary.

2. The vehicle speed control device according to claim 1, further comprising:
a storage configured to store past records of control for the vehicle, wherein
the predetermined condition regards existence or nonexistence of the past records of control for the vehicle, and
the information processor determines whether to output the deceleration confirmation signal, based on the existence or nonexistence of the past records of control stored in the storage.

3. The vehicle speed control device according to claim 2, wherein
the information processor determines that the past records of control do not exist, when a radius of curvature of the curved road is outside a predetermined range compared to the past records of control.

4. The vehicle speed control device according to claim 2, wherein
the information processor outputs the deceleration confirmation signal, when the past records of control do not exist.

5. The vehicle speed control device according to claim 4, wherein
when the information processor receives a deceleration request after outputting the deceleration confirmation signal, the information processor outputs a deceleration control signal for performing deceleration control of the vehicle speed, the deceleration request indicating that the reduction of vehicle speed is necessary.

6. The vehicle speed control device according to claim 1, wherein
the information processor outputs the deceleration confirmation signal to a notification device that is communicably connected to the vehicle speed control device.

7. The vehicle speed control device according to claim 2, wherein
the information processor determines that the past records of control exist, when a radius of curvature of the curved road is within a predetermined range compared to the past records of control.

8. The vehicle speed control device according to claim 2, wherein
when the past records of control exist, the information processor outputs a deceleration control signal for performing deceleration control of the vehicle speed based on the past records of control, without outputting the deceleration confirmation signal.

9. The vehicle speed control device according to claim 5, wherein
the deceleration control signal includes information regarding deceleration control details for reducing the vehicle speed before the vehicle enters the curved road.

10. The vehicle speed control device according to claim 9, wherein
the deceleration control details include details regarding a deceleration start timing, a deceleration end timing, vehicle speed after deceleration, and speed change from start of deceleration to end of deceleration.

11. The vehicle speed control device according to claim 4, wherein
preset information including a deceleration permission setting for the vehicle is stored in the storage, and
when a deceleration request is not obtained by a predetermined timing after the deceleration confirmation signal is outputted, the information processor determines, based on the deceleration permission setting, whether to output a deceleration control signal for performing deceleration control of the vehicle speed, the deceleration request indicating that the reduction of vehicle speed is necessary.

12. The vehicle speed control device according to claim 11, wherein
the information processor outputs the deceleration control signal when the deceleration permission setting indicates that deceleration is permitted, and does not output the deceleration control signal when the deceleration permission setting indicates that deceleration is not permitted.

13. The vehicle speed control device according to claim 2, wherein
the information processor determines the existence or nonexistence of past records of control that are in accordance with a driver of the vehicle, and, when past records of control by the driver exist, the information processor outputs a deceleration control signal for performing deceleration control of the vehicle speed, based on the past records of control.

14. The vehicle speed control device according to claim 5, wherein
after the deceleration control of the vehicle speed is executed during turning by the vehicle on the curved road, the information processor outputs a satisfaction level confirmation signal for confirming a level of satisfaction of the occupant regarding the deceleration control.

15. A vehicle speed control system comprising:
the vehicle speed control device according to claim 1;
a detection device that outputs, to the vehicle speed control device, detection information regarding the curved road and a speed of the vehicle; and
a notification device that notifies the occupant of confirmation as to whether reduction of vehicle speed is necessary, based on the deceleration confirmation signal.

16. An information processing method comprising:
obtaining information regarding a curved road in a travel direction of a vehicle; and
outputting, under a predetermined condition, before the vehicle enters the curved road, a deceleration confirmation signal for confirming, with an occupant of the vehicle, whether reduction of vehicle speed is necessary.
